(19) United States
(12) Patent Application Publication
(10) Pub. No.: US 2026/0228752 A1
(43) Pub. Date: Aug. 6, 2026

(54) Communication Customization via Sentiment Profile

(71) Applicant: Dell Products L.P., Round Rock, TX (US)

(72) Inventors: Ophir Buchman, Raanana (IL); Yevgeni Gehtman, Modi'in (IL); Omer Aharony, Newton, MA (US)

(21) Appl. No.: 19/046,300

(22) Filed: Feb. 5, 2025

(51) Int. Cl. G06Q 30/015

(52) U.S. Cl. CPC G06Q 30/015

(57) ABSTRACT

A system can, prior to conducting a support communication session with a user account, generate a sentiment profile for the user account based on interaction data representative of interactions via communications by the user account, wherein the interactions comprise first data representative of first types of queries via the user account and second types of responses via the user account that satisfy a specified interactions criterion, second data representative of patterns in behavior associated with the user account, and third data representative of respective contexts of the interactions, wherein the sentiment profile indicates a communication style to use when interacting with the user profile. The system can conduct the support communication session using an artificial intelligence virtual agent, wherein the artificial intelligence virtual agent determines what to communicate with the user account based at least in part on the sentiment profile for the user account.

### BACKGROUND

Users of computer equipment can communicate with vendors of the computer equipment.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, prior to conducting a support communication session relating to support associated with a user account, generate a sentiment profile for the user account based on interaction data representative of interactions via communications between the user account and an entity that is associated with the system, wherein the interactions comprise first data representative of first types of queries via the user account and second types of responses via the user account that satisfy a specified interactions criterion, second data representative of patterns in behavior associated with the user account, and third data representative of respective contexts of the interactions, and wherein the sentiment profile indicates a communication style to use when interacting with the user profile. The system can conduct the support communication session relating to support associated with the user account using an artificial intelligence virtual agent, wherein the artificial intelligence virtual agent determines what to communicate with the user account based at least in part on the sentiment profile for the user account.

An example method can comprise creating, by a system comprising at least one processor, a sentiment profile corresponding to a user account based on interactions between the user account and an entity that is associated with the system, wherein the interactions comprise first data indicating types of queries and responses by the user account contained in the interactions that satisfy a specified interactions criterion, second data indicating patterns in behavior associated with the user account contained in the interactions, or third data indicating respective contexts of the interactions. The method can further comprise, after creating the sentiment profile, conducting, by the system, a support communication session with the user account via an artificial intelligence virtual agent, wherein the artificial intelligence virtual agent determines what to communicate with the user account based on the sentiment profile for the user account.

An example non-transitory computer-readable medium can comprise instructions that, in response to execution, cause a system comprising a processor to perform operations. These operations can comprise creating a sentiment model for a user account based on interaction data representing interactions based on user input received during the interactions via the user account and entity input received during the interactions via an entity that is associated with the system, wherein the interactions comprise first data indicating types of at least one of queries or responses represented in the user input that satisfy a defined interactions criterion, second data indicating patterns in behavior associated with the user input, or third data indicating contexts of the interactions. These operations can further comprise, after creating the sentiment model and based on the sentiment model, initiating a communication session with the user account via a virtual agent, wherein the virtual agent is to conduct the communication session based on the sentiment profile.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate communication customization via sentiment profile, in accordance with an embodiment of this disclosure;

FIG. 2 illustrates an example that can facilitate communication customization via sentiment profile, in accordance with an embodiment of this disclosure;

FIG. 3 illustrates another example that can facilitate communication customization via sentiment profile, in accordance with an embodiment of this disclosure;

FIG. 4 illustrates another example that can facilitate communication customization via sentiment profile, in accordance with an embodiment of this disclosure;

FIG. 5 illustrates another example that can facilitate communication customization via sentiment profile, in accordance with an embodiment of this disclosure;

FIG. 6 illustrates an example process flow that can facilitate communication customization via sentiment profile, in accordance with an embodiment of this disclosure;

FIG. 7 illustrates another example process flow that can facilitate communication customization via sentiment profile, in accordance with an embodiment of this disclosure;

FIG. 8 illustrates another example process flow that can facilitate communication customization via sentiment profile, in accordance with an embodiment of this disclosure;

FIG. 9 illustrates an example block diagram of a computer operable to execute an embodiment of this disclosure.

### DETAILED DESCRIPTION

### Overview

Artificial intelligence virtual agents can interact with user accounts, such as via voice or text communications. AI virtual agents can be used in scenarios such as supporting users in purchasing products from a vendor, and supporting users in using products from the vendor.

AI virtual agents can provide a unified user experience based on a standard defined by the vendor. This standard can be based on factors such as politeness, response length, language complexity, culture sensitivity, and feedback frequency.

This approach can have a drawback in that it is not personalized for particular user accounts.

The present techniques can be implemented to facilitate personalizing AI virtual agents for particular user accounts. The present techniques can leverage previous interactions with a user account (e.g., with a human, and/or with a virtual agent) to build a sentiment profile for the user account, and by using mechanisms such as,
Tracking types of queries and responses that a user account prefers (e.g., whether a customer frequently engages in small talk);
Identifying patterns in user account behavior (e.g., providing more detailed responses if a user account often asks for detailed explanations); and
Using context from previous interactions to inform current responses.

This sentiment profile can be provided to a virtual agent when a support call with the user account begins.

The present techniques can be implemented to facilitate communication customization based on a pre-built (pre-call) sentiment profile.

Generally, in prior approaches, a virtual agent is provided with a predefined static sentiment profile, rather than one that is dynamically updated until the point of the support call occurring.

### Example Architectures, Etc.

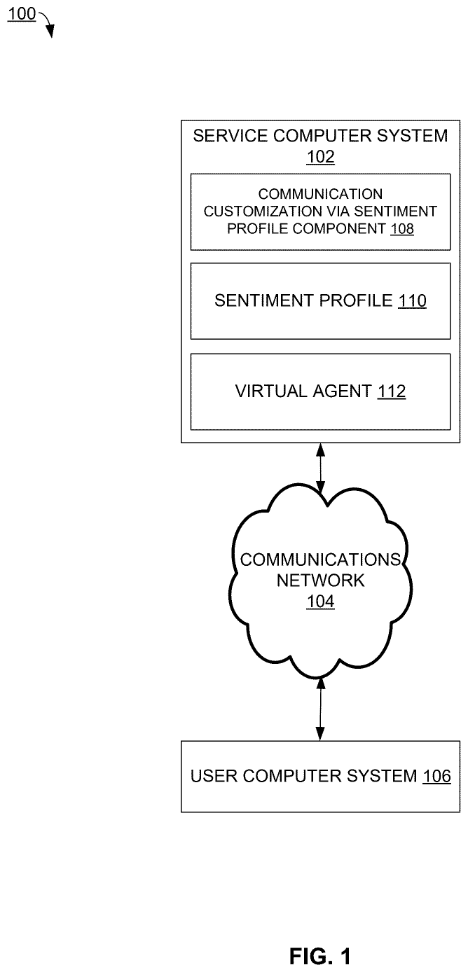

FIG. 1 illustrates an example system architecture 100 that can facilitate communication customization via sentiment profile, in accordance with an embodiment of this disclosure.

System architecture 100 comprises service computer system 102, communications network 104, and user computer system 106. Service computer system 102 comprises communication customization via sentiment profile component 108, sentiment profile 110, and virtual agent 112.

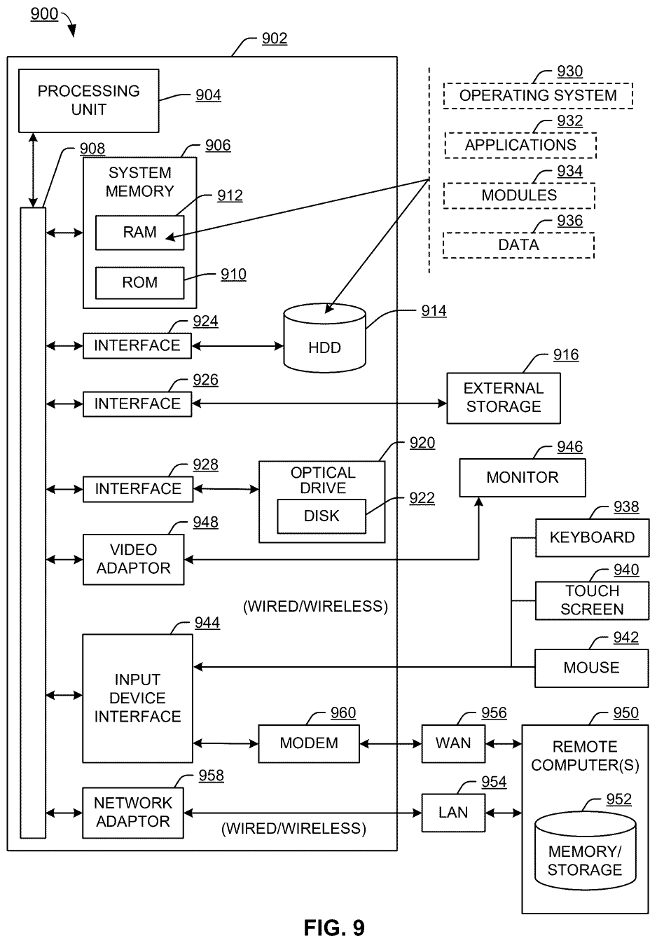

Each of service computer system 102 and/or user computer system 106 can be implemented with part(s) of computing environment 900 of FIG. 9. Communications network 104 can comprise a computer communications network, such as the Internet.

Communication customization via sentiment profile component 108 can create sentiment profile 110 for a particular user account, where sentiment profile 110 can generally indicate preferences of the user account in communication, and can be dynamically updated based on information about user account, such as interactions between the user account and an entity associated with service computer system 102. When the user account initiates a chat session with virtual agent 112 (e.g., using user computer system 106 and via communications network 104), virtual agent 112 can access the sentiment profile for that user account among a group of sentiment profiles for different user accounts, and use that sentiment profile in determining how to communicate with the user account (e.g., an amount of detail to give in explanations, or whether to engage in small talk). This user-specific approach can increase user satisfaction in those communications.

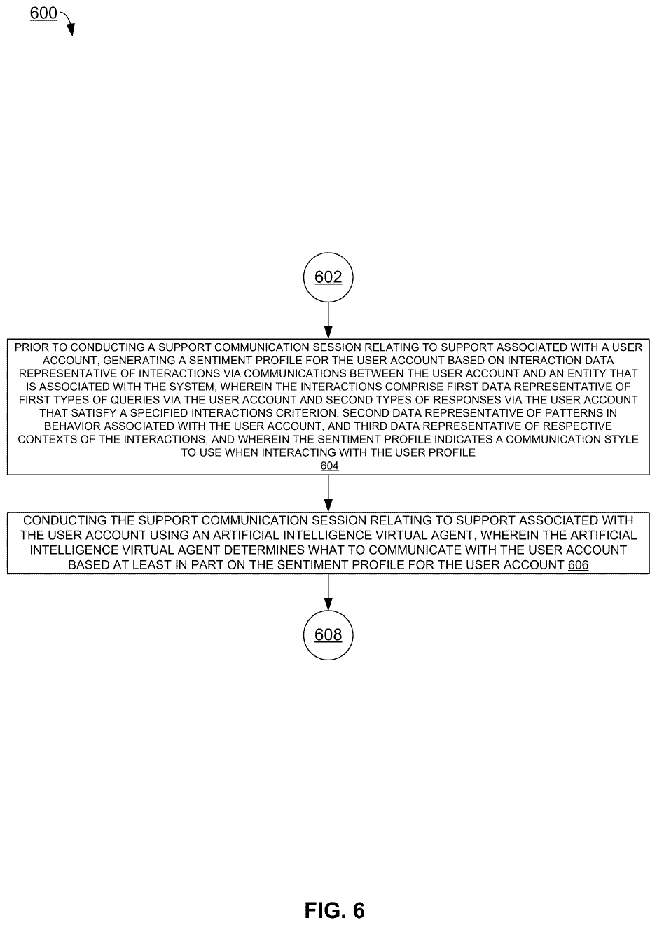

In some examples, communication customization via sentiment profile component 108 can implement part(s) of the process flows of FIGS. 6-8 to implement communication customization via sentiment profile.

It can be appreciated that system architecture 100 is one example system architecture for communication customization via sentiment profile, and that there can be other system architectures that facilitate communication customization via sentiment profile.

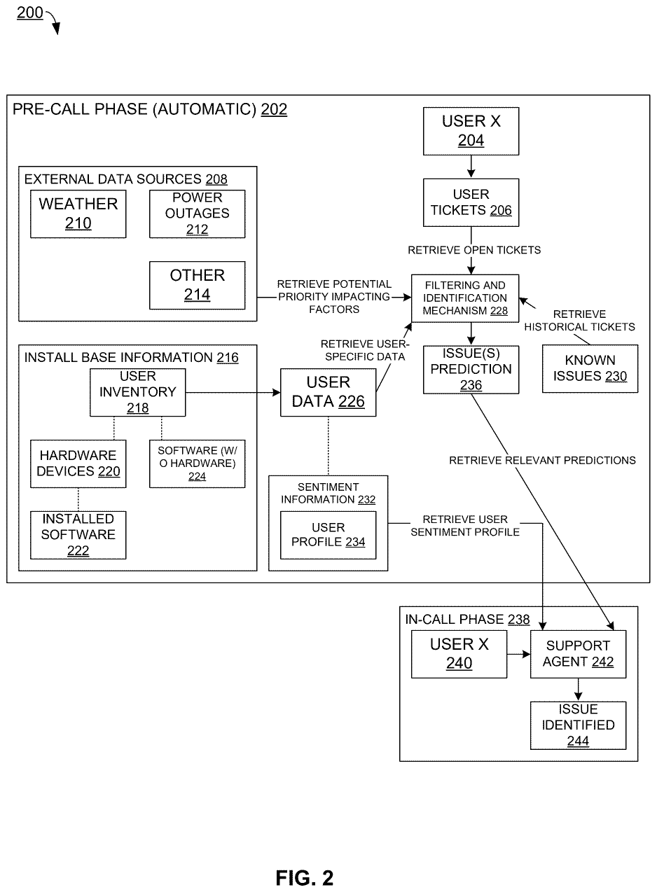

FIG. 2 illustrates an example 200 that can facilitate communication customization via sentiment profile, in accordance with an embodiment of this disclosure. In some examples, part(s) of example 200 can be implemented by part(s) of system architecture 100 of FIG. 1 to facilitate communication customization via sentiment profile.

Example 200 comprises pre-call phase (automatic) 202, user X 204, user tickets 206, external data sources 208, weather 210, power outages 212, other 214, install base information 216, user inventory 218, hardware devices 220, installed software 222, software (without hardware) 224, user data 226, filtering and identification mechanism 228, known issues 230, sentiment information 232, user profile 234, issue(s) prediction 236, in-call phase 238, user X 240, support agent 242, and issue identified 244.

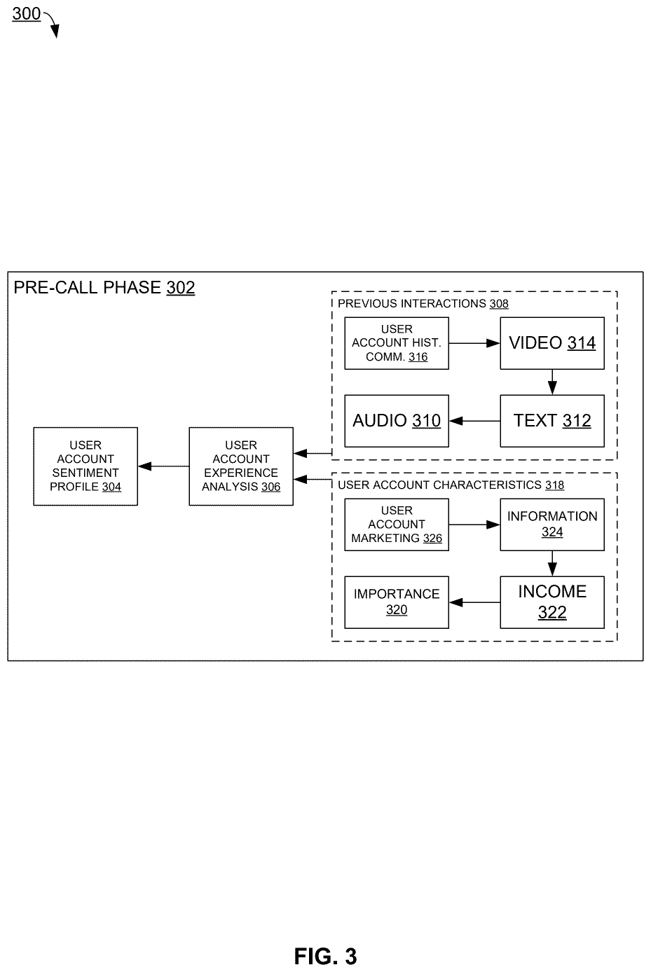

FIG. 3 illustrates another example 300 that can facilitate communication customization via sentiment profile, in accordance with an embodiment of this disclosure. In some examples, part(s) of example 300 can be implemented by part(s) of system architecture 100 of FIG. 1 to facilitate communication customization via sentiment profile.

Example 300 comprises pre-call phase 302, user account sentiment profile 304, user account experience analysis 306, previous interactions 308, audio 310, text 312, video 314, user account historical communication 316, user account characteristics 318, importance 320, income 322, information 324, and user account marketing 326.

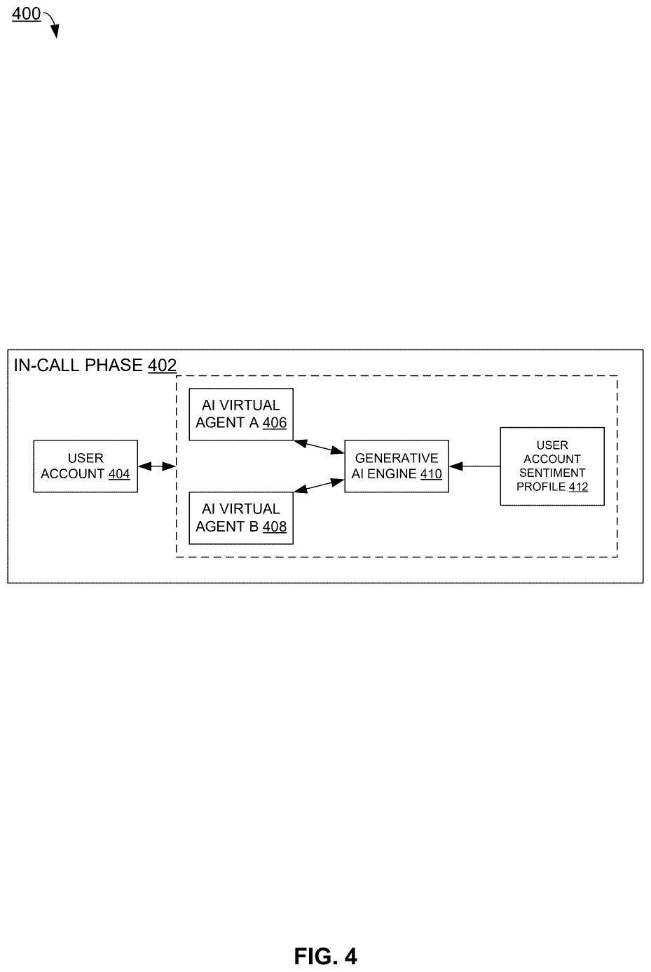

Example 300 illustrates a pre-call phase where a sentiment profile for a user account can be created (e.g., user account sentiment profile 304). This user account sentiment profile can then be used by an AI virtual agent during the in-call phase of example 400 of FIG. 4.

FIG. 4 illustrates another example 400 that can facilitate communication customization via sentiment profile, in accordance with an embodiment of this disclosure. In some examples, part(s) of example 400 can be implemented by part(s) of system architecture 100 of FIG. 1 to facilitate communication customization via sentiment profile.

Example 400 comprises in-call phase 402, user account 404, AI virtual agent A 406, AI virtual agent B 408, generative AI engine 410, and user account sentiment profile 412.

Example 400 illustrates an in-call phase where a sentiment profile for a user account (e.g., user account sentiment profile 412) that was created during the pre-call phase of example 300 of FIG. 3 can be used by an AI virtual agent in communication session (e.g., a support call) with a user account.

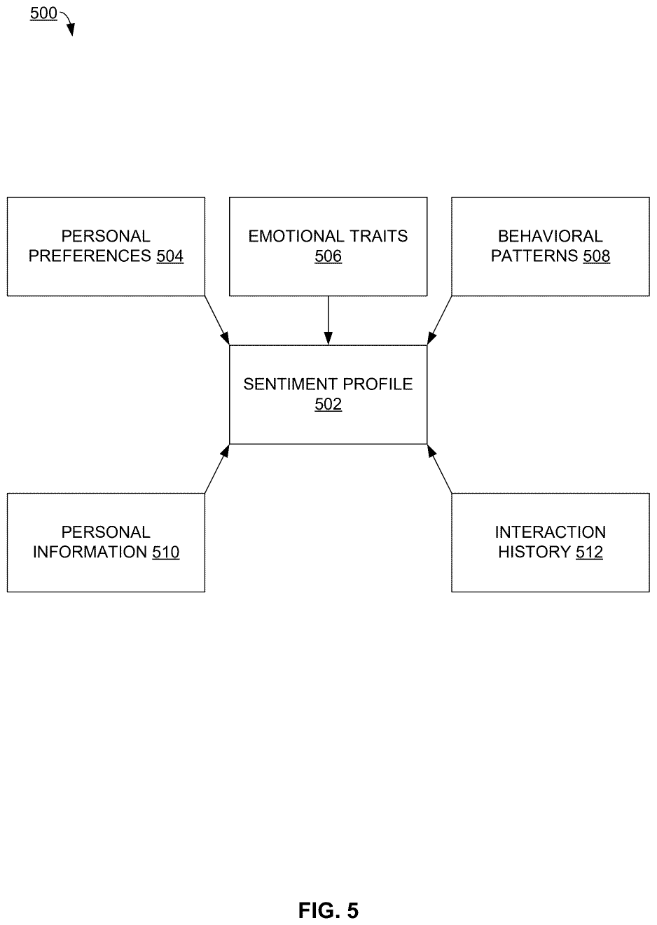

FIG. 5 illustrates another example 500 that can facilitate communication customization via sentiment profile, in accordance with an embodiment of this disclosure. In some examples, part(s) of example 500 can be implemented by part(s) of system architecture 100 of FIG. 1 to facilitate communication customization via sentiment profile.

Example 500 comprises sentiment profile 502, personal preferences 504, emotional traits 506, behavioral patterns 508, personal information 510, and interaction history 512.

In example 500, a sentiment profile can be created based on various information types.

A sentiment profile as used herein can extend beyond indicating “positive” or “negative” and can comprise elements of a user or user account's personality and/or mood.

Personal preferences 504 can include information such as, an amount of small talk preferred, a sense of humor (e.g., dry, witty, slapstick), favorite topics of conversation (e.g., sports, technology, travel), and preferred communication style (e.g., formal, casual).

Emotional traits 506 can include information such as typical emotional state (e.g., optimistic, anxious), sensitivity to certain topics, and stress levels and coping mechanisms.

Behavioral patterns 508 can include information such as frequency and timing of interactions, preferred communication channels (e.g., text, voice), and engagement level (e.g., active, passive).

Personal information 510 can include information such as family details (e.g., names, relationships), hobbies and interests, and professional background.

Interaction history 512 can include information such as previous conversations and topics discussed, notable events or milestones mentioned, and feedback and satisfaction levels.

Generating this data of example 500 can be performed by analyzing calls and other communications, which can be performed via artificial intelligence techniques. Such techniques can comprise converting video into text (that is, sound to transcript); identifying the parties talking in a sound recording, and isolating the user's speech (voice recognition); analyzing a call transcript to identify speech style; and analyzing a user's tone change/stress level by comparing a current voice recording (and/or transcript) to a baseline.

### Example Process Flows

FIG. 6 illustrates an example process flow 600 that can facilitate communication customization via sentiment profile, in accordance with an embodiment of this disclosure. In some examples, one or more embodiments of process flow 600 can be implemented by communication customization via sentiment profile component 108 of FIG. 1, or computing environment 900 of FIG. 9.

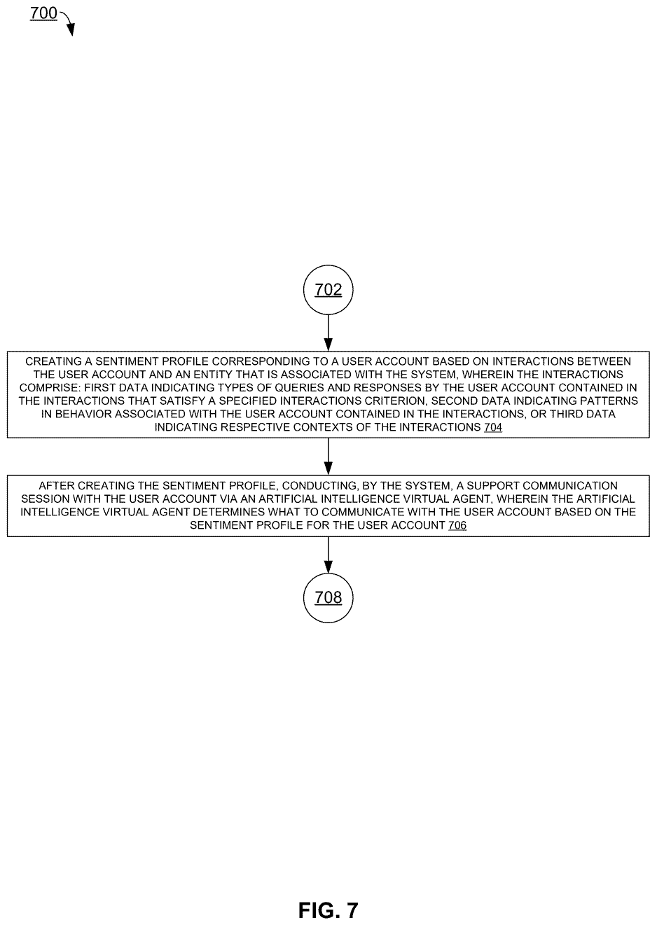

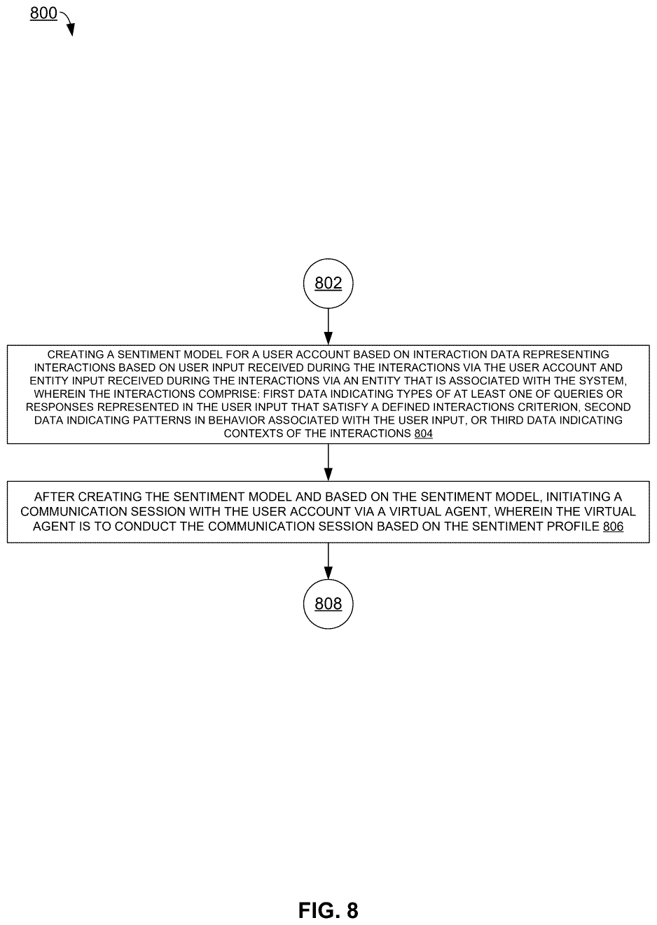

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, and/or process flow 800 of FIG. 8.

Process flow 600 begins with 602, and moves to operation 604.

Operation 604 depicts, prior to conducting a support communication session relating to support associated with a user account, generating a sentiment profile for the user account based on interaction data representative of interactions via communications between the user account and an entity that is associated with the system, wherein the interactions comprise first data representative of first types of queries via the user account and second types of responses via the user account that satisfy a specified interactions criterion, second data representative of patterns in behavior associated with the user account, and third data representative of respective contexts of the interactions, and wherein the sentiment profile indicates a communication style to use when interacting with the user profile. This can be similar to generating a sentiment profile as depicted in example 300 of FIG. 3.

As described with respect to FIG. 5, a sentiment profile as used herein can extend beyond indicating “positive” or “negative” and can comprise elements of a user or user account's personality and/or mood. The elements of a user or user account's personality and/or mood in a sentiment profile can be used to determine how an artificial intelligence virtual agent communicates with that user or user account.

After operation 604, process flow 600 moves to operation 606.

Operation 606 depicts conducting the support communication session relating to support associated with the user account using an artificial intelligence virtual agent, wherein the artificial intelligence virtual agent determines what to communicate with the user account based at least in part on the sentiment profile for the user account. This can be similar to using a user sentiment profile in a virtual agent chat session with that user as depicted in example 400 of FIG. 4.

In some examples, the sentiment profile is provided to the artificial intelligence virtual agent during an initial part of the support communication session that satisfies an initial portion criterion that specifies whether the initial part of the support communication session has been finished. That is, the virtual agent can load the sentiment profile at the start of the chat session (and the sentiment profile can be updated until the point at which it is loaded; in some examples the sentiment profile can be updated during the session).

In some examples, the artificial intelligence virtual agent is a first artificial intelligence virtual agent, the support communication session is a first support communication session relating to first support associated with the user account, and a second artificial intelligence virtual agent is configured to access the sentiment profile as part of a second support communication session relating to second support associated with the user account. That is, multiple agents can use a user's sentiment profile, such as depicted in example 400 of FIG. 4.

In some examples, the interactions via the communications between the user account and the entity comprise previous interactions via previous communications between the user account and a support agent. That is, the interactions can be those that occur between the user account and a human.

In some examples, the artificial intelligence virtual agent is a first artificial intelligence virtual agent, and the interactions via the communications between the user account and the entity comprise first interactions via first communications between the user account and the first artificial intelligence virtual agent or second interactions via second communications between the user account and a second artificial intelligence virtual agent. That is, the interactions can be those that occur between the user account and an AI virtual agent.

In some examples, operation 606 comprises updating the sentiment profile after completing the support communication session. That is, a communication session in which a sentiment profile is used can be used to update that sentiment profile.

After operation 606, process flow 600 moves to 608, where process flow 600 ends.

FIG. 7 illustrates an example process flow 700 that can facilitate communication customization via sentiment profile, in accordance with an embodiment of this disclosure. In some examples, one or more embodiments of process flow 700 can be implemented by communication customization via sentiment profile component 108 of FIG. 1, or computing environment 900 of FIG. 9.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, and/or process flow 800 of FIG. 8.

Process flow 700 begins with 702, and moves to operation 704.

Operation 704 depicts creating a sentiment profile corresponding to a user account based on interactions between the user account and an entity that is associated with the system, wherein the interactions comprise: first data indicating types of queries and responses by the user account contained in the interactions that satisfy a specified interactions criterion, second data indicating patterns in behavior associated with the user account contained in the interactions, or third data indicating respective contexts of the interactions.

In some examples, operation 704 can be implemented in a similar manner as operation 604 of FIG. 6.

In some examples, the interactions comprise audio data representative of audio contained in the interactions. This can be similar to audio 310 of FIG. 3.

In some examples, the interactions comprise text data representative of text contained in the interactions. This can be similar to text 312 of FIG. 3.

In some examples, the interactions comprise video data representative of video contained in the interactions. This can be similar to video 314 of FIG. 3.

In some examples, the creating of the sentiment profile is performed based on characteristics of the user account that are separate from the interactions between the user account and the entity. This can be similar to user account characteristics 318 of FIG. 3.

In some examples, the characteristics of the user account comprise an indication that the user account satisfies an importance criterion. This can be similar to importance 320 of FIG. 3.

In some examples, the characteristics of the user account comprise an amount of income associated with the user account. This can be similar to income 322 of FIG. 3.

After operation 704, process flow 700 moves to operation 706.

Operation 706 depicts, after creating the sentiment profile, conducting a support communication session with the user account via an artificial intelligence virtual agent, wherein the artificial intelligence virtual agent determines what to communicate with the user account based on the sentiment profile for the user account. In some examples, operation 706 can be implemented in a similar manner as operation 606 of FIG. 6.

In some examples, operation 706 comprises accessing the sentiment model, by the virtual agent, after an initialization of the support communication session. That is, the virtual agent can load the sentiment profile at the start of the chat session (and the sentiment profile can be updated until the point at which it is loaded; in some examples the sentiment profile can be updated during the session).

After operation 706, process flow 700 moves to 708, where process flow 700 ends.

FIG. 8 illustrates an example process flow 800 that can facilitate communication customization via sentiment profile, in accordance with an embodiment of this disclosure. In some examples, one or more embodiments of process flow 800 can be implemented by communication customization via sentiment profile component 108 of FIG. 1, or computing environment 900 of FIG. 9.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, and/or process flow 700 of FIG. 7.

Process flow 800 begins with 802, and moves to operation 804.

Operation 804 depicts creating a sentiment model for a user account based on interaction data representing interactions based on user input received during the interactions via the user account and entity input received during the interactions via an entity that is associated with the system, wherein the interactions comprise: first data indicating types of at least one of queries or responses represented in the user input that satisfy a defined interactions criterion, second data indicating patterns in behavior associated with the user input, or third data indicating contexts of the interactions. In some examples, operation 804 can be implemented in a similar manner as operation 604 of FIG. 6.

In some examples, the creating of the sentiment model is based on emotional trait data representative of an emotional trait that is associated with the user account. This can be similar to emotional traits 506 of FIG. 5.

In some examples, the creating of the sentiment model is based on behavioral pattern data representative of a behavioral pattern that is associated with the user account. This can be similar to behavioral patterns 508 of FIG. 5.

In some examples, the creating of the sentiment model is based on personal preference data representative of a personal preference that is associated with the user account. This can be similar to personal preferences 504 of FIG. 5.

After operation 804, process flow 800 moves to operation 806.

Operation 806 depicts, after creating the sentiment model and based on the sentiment model, initiating a communication session with the user account via a virtual agent, wherein the virtual agent is to conduct the communication session based on the sentiment profile. In some examples, operation 806 can be implemented in a similar manner as operation 606 of FIG. 6.

In some examples, operation 806 comprises determining a predicted issue with computer equipment that is associated with the user account, wherein the initiating of the communication session is further based on the predicted issue. This can be similar to example 200 of FIG. 2, where retrieve relevant predictions occurs between issue(s) prediction 236 and support agent 242.

In some examples, operation 806 comprises accessing the sentiment model, by the virtual agent, after an initialization of the communication session.

After operation 806, process flow 800 moves to 808, where process flow 800 ends.

### Example Operating Environment

In order to provide additional context for various embodiments described herein, FIG. 9 and the following discussion are intended to provide a brief, general description of a suitable computing environment 900 in which the various embodiments of the embodiment described herein can be implemented.

For example, parts of computing environment 900 can be used to implement one or more embodiments of service computer system 102, and/or user computer system 106.

In some examples, computing environment 900 can implement one or more embodiments of the process flows of FIGS. 6-8 to facilitate communication customization via sentiment profile.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a nonvolatile storage such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet.

The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples, and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
at least one processor; and
at least one memory that stores executable instructions that, when executed by the at least one processor, facilitate performance of operations, comprising:
prior to conducting a first support communication session relating to support associated with a user account, generating a sentiment profile for the user account based on interaction data representative of interactions via communications between the user account and an entity that is associated with the system, wherein the interactions comprise,
first data representative of first types of queries via the user account and second types of responses via the user account that satisfy a specified interactions criterion,
second data representative of patterns in behavior associated with the user account, and
third data representative of respective contexts of the interactions, and
wherein the sentiment profile indicates a communication style to use when interacting with the user profile;
conducting the first support communication session relating to support associated with the user account using a first artificial intelligence virtual agent, wherein the first artificial intelligence virtual agent determines what to communicate with the user account based at least in part on the sentiment profile for the user account; and
conducting a second support communication session relating to support associated with the user account using a second artificial intelligence virtual agent, wherein the second artificial intelligence virtual agent determines what to communicate with the user account based at least in part on the sentiment profile for the user account, and wherein the first artificial intelligence virtual agent differs from the second artificial intelligence virtual agent.

2. The system of claim 1, wherein the sentiment profile is provided to the first artificial intelligence virtual agent during an initial part of the first support communication session that satisfies an initial portion criterion that specifies whether the initial part of the first support communication session has been finished.

3. (canceled)

4. The system of claim 1, wherein the interactions via the communications between the user account and the entity comprise previous interactions via previous communications between the user account and a support agent.

5. The system of claim 1, wherein the interactions via the communications between the user account and the entity comprise first interactions via first communications between the user account and the first artificial intelligence virtual agent or second interactions via second communications between the user account and the second artificial intelligence virtual agent or a third artificial intelligence virtual agent.

6. The system of claim 1, wherein the operations further comprise:
updating the sentiment profile after completing the first support communication session.

7. A method, comprising:
creating, by a system comprising at least one processor, a sentiment profile corresponding to a user account based on interactions between the user account and an entity that is associated with the system, wherein the interactions comprise:
first data indicating types of queries and responses by the user account contained in the interactions that satisfy a specified interactions criterion,
second data indicating patterns in behavior associated with the user account contained in the interactions, or
third data indicating respective contexts of the interactions;
after creating the sentiment profile, conducting, by the system, a first support communication session with the user account via a first artificial intelligence virtual agent, wherein the first artificial intelligence virtual agent determines what to communicate with the user account based on the sentiment profile for the user account; and
conducting, by the system, a second support communication session with the user account using a second artificial intelligence virtual agent, wherein the second artificial intelligence virtual agent determines what to communicate with the user account based on the sentiment profile for the user account, and wherein the first artificial intelligence virtual agent differs from the second artificial intelligence virtual agent.

8. The method of claim 7, wherein the interactions comprise audio data representative of audio contained in the interactions.

9. The method of claim 7, wherein the interactions comprise text data representative of text contained in the interactions.

10. The method of claim 7, wherein the interactions comprise video data representative of video contained in the interactions.

11. The method of claim 7, wherein the creating of the sentiment profile is performed based on characteristics of the user account that are separate from the interactions between the user account and the entity.

12. The method of claim 11, wherein the characteristics of the user account comprise an indication that the user account satisfies an importance criterion.

13. The method of claim 11, wherein the characteristics of the user account comprise an amount of income associated with the user account.

14. The method of claim 11, further comprising:
accessing the sentiment model, by the first virtual agent, after an initialization of the first support communication session.

15. A non-transitory computer-readable medium comprising instructions that, in response to execution, cause a system comprising at least one processor to perform operations, comprising:
creating a sentiment model for a user account based on interaction data representing interactions based on user input received during the interactions via the user account and entity input received during the interactions via an entity that is associated with the system, wherein the interactions comprise:
first data indicating types of at least one of queries or responses represented in the user input that satisfy a defined interactions criterion,
second data indicating patterns in behavior associated with the user input, or third data indicating contexts of the interactions;
after creating the sentiment model and based on the sentiment model, initiating a first communication session with the user account via a first virtual agent, wherein the first virtual agent is to conduct the first communication session based on the sentiment profile; and
initiating a second communication session with the user account via a second virtual agent, wherein the second virtual agent is to conduct the second communication session based on the sentiment profile.

16. The non-transitory computer-readable medium of claim 15, wherein the creating of the sentiment model is based on emotional trait data representative of an emotional trait that is associated with the user account.

17. The non-transitory computer-readable medium of claim 15, wherein the creating of the sentiment model is based on behavioral pattern data representative of a behavioral pattern that is associated with the user account.

18. The non-transitory computer-readable medium of claim 15, wherein the creating of the sentiment model is based on personal preference data representative of a personal preference that is associated with the user account.

19. The non-transitory computer-readable medium of claim 15, wherein the operations further comprise:
determining a predicted issue with computer equipment that is associated with the user account, wherein the initiating of the communication session is further based on the predicted issue.

20. The non-transitory computer-readable medium of claim 15, wherein the operations further comprise:
accessing the sentiment model, by the first virtual agent, after an initialization of the communication session.

21. The non-transitory computer-readable medium of claim 15, wherein the operations further comprise:
updating the sentiment profile after completing the first support communication session.
